(19) United States
(12) Patent Application Publication
(10) Pub. No.: US 2017/0043369 A1
(43) Pub. Date: Feb. 16, 2017

(54) SURFACE COATING METHOD AND DEVICE FOR CARRYING OUT SAID METHOD

(71) Applicants: UNIVERSITE PIERRE ET MARIE CURIE (PARIS 6), Paris (FR); CENTRE NATIONAL DE LA RECHERCHE SCIENTIFIQUE, Paris (FR)

(72) Inventors: David Grosso, Cheptainville (FR); Benjamin Louis, Paris (FR)

(73) Assignees: UNIVERSITE PIERRE ET MARIE CURIE (PARIS 6), Paris (FR); CENTRE NATIONAL DE LA RECHERCHE SCIENTIFIQUE, Paris (FR)

(21) Appl. No.: 15/118,818

(22) PCT Filed: Feb. 12, 2015
(86) PCT No.: PCT/IB2015/051061

§ 371 Date: Aug. 12, 2016

(30) Foreign Application Priority Data
Feb. 13, 2014 (FR) 1451132

(51) Int. Cl. B05D 1/02; B65D 83/30

(52) U.S. Cl. CPC B05D 1/02; B65D 83/303

(57) ABSTRACT

A surface coating method includes the steps of preparing a solution containing a solvent and a material or its precursor, intended to cover a surface to be coated, which is non-volatile, film-forming and soluble or can be in suspension or dispersed in a solvent; and generating an aerosol of the solution. The method further includes generating an aerosol flow from a first end of a tube towards a second end of the tube, wherein the second end pre-determined cross-section (Se) and provided with a spray nozzle having an outlet with a cross-section (S) smaller than the cross-section (Se) of the second end of the tube, such that the ratio R1=F/S is greater than 4 metres per second. The method also includes the steps of directing the outlet of the nozzle towards the surface to be coated and spraying the aerosol onto the surface to be coated.

The invention relates to a method for coating a surface and to a device for applying it.

Many industries and many applications require homogeneous coating of surfaces, i.e. the deposited layer should have a substantially constant thickness (with an allowed variation of + or −15%).

In particular, there exists a need for coating surfaces with a so-called <<optical quality>> layer, i.e. the layer deposited on the surface is neither opaque, nor too diffusing, substantially has the same interference properties in the visible domain and has the same optical properties on all the areas of the coated surface. The determination of the optical quality of a deposit is a standard operation of one skilled in the art.

As the optical properties are dependent on the composition, on the structure and on the thickness of the layer, it is primordial that the coating technique give the possibility that these three characteristics remain as homogeneous as possible over the whole of the surface. For example, an anti-reflective layer on glass should have a typical thickness from 120 nm±15% and a refractive index of 1.24±5%.

Such a coating is still more difficult when the surface is complex, i.e. when it is not planar, or/and is very large. Thus, the coating of a long pipe or of a glazing, for example, is excessively difficult and time-consuming.

There already exist methods for coating surfaces from liquid solutions. Mention may be made of capillary coating, by immersion, by a centrifugal force or by spraying of a coating material as an aerosol.

The invention relates to coating by spraying.

The general principle of this method consists of placing in a tank, a solution containing the coating material and a solvent, and then of generating microdroplets, for example by means of an atomizer.

Mention may be made of a pneumatic atomizer, notably by impact, of an ultrasonic atomizer or an electrostatic atomizer. In the three cases, the solution is transformed into droplets, by pressure forces, vibration/cavitation forces and electrostatic repulsion/attraction forces which overcome the surface tension forces and the viscosity forces governing the initial state of the solution.

The generated microdroplets typically have a rated size of a few microns in diameter ±300%. The greatest droplets settle, i.e. they fall in the tank, while the smallest ones form an aerosol and are characterized in that they are subject to Brownian motion without settling.

The smallest droplets are then carried away by a carrier gas towards the object to be coated.

Several methods use this principle.

For example, document EP 0 486 393, in the name of Langlet et al. describes a method and a device for coating a surface by spraying, wherein the spraying is carried out in a closed and leak-proof reactor for which it is possible to control the composition of the atmosphere and to thus limit the evaporation of the solvent before the droplets are deposited on the surface to be coated. The device does not use any nozzle, in the sense that there is no acceleration of the aerosol. Indeed, the aerosol flow is driven towards the top of the reactor and encounters a second flow of carrier gas directed towards the object to be coated. The conical shape of the reactor moving away towards the surface to be coated induces a reduction in the velocity of the aerosol.

In the article of Langlet et al., “Ultrasonic pulverization of an aerosol: a versatile tool for the deposition of sol-gel thin films”, sol-gel science and technology handbook Vol. 1, Sol-gel processing, Editor H. Kozuka, Kluwer Academic Publishers (2005) 289-307, the author specifies that a laminar flow of aerosol should be obtained in order to limit turbulences and promote uniformity of the deposit. For this purpose, the flow rate of the aerosol flow should be limited to about 1 litre per minute.

Other authors have also confirmed the essential nature of low velocity in order to obtain good quality coating (optical quality). For example, mention may be made of SONO-TEK who describes, on their internet site http://www.sono-tek.com that its devices allow limited ejection velocity, typically of the order of 7.6 to 12.7 centimeters per second (3-5 inches per second).

In this device, the flow is not accelerated but simply confined in a certain geometry by means of a compressed air sleeve. In this case, the droplets cannot diffuse out of the sleeve but their velocity is not increased.

It results from the prior art that a homogeneous coating can only be obtained if the aerosol flow is slow. Indeed, with the methods of the prior art, the aerosol flow is maintained to be slow so as to avoid turbulences within the aerosol flow and to project a regular number of droplets per unit surface of substrate to be coated, in order to obtain a homogeneous layer after total evaporation of the solvent.

Present methods are therefore slow since they involve low velocities. Further, in order to limit the evaporation and to allow coating with a specific shape, the state of the art proposes producing the coating in a controlled atmosphere, i.e. in a closed and leak-proof reactor. This gives the possibility of saturating the atmosphere with solvent (limits the evaporation) and of conforming the aerosol flow in a controlled way by using compressed air jets around the aerosol flow (the compressed air jets do not mix with the aerosol) in order to model it and define a specific shape of the aerosol flow without accelerating it.

The object of the present invention is therefore to propose a surface coating method and device, allowing simple, rapid and homogeneous coating (in structure, in composition and in thickness) of a surface, optionally a complex surface.

For this, the invention proposes going against present practices by spraying over the relevant surface a coating material as an aerosol with a nozzle in order to very strongly accelerate the material flow relatively to the existing devices. Unexpectedly, this acceleration of the droplets generates a homogeneous layer with an accurate and adjustable thickness.

For this purpose, the object of the invention is a method for coating a surface by spraying an aerosol over a surface, comprising the following steps:
A) providing a surface to be coated;
B) preparing a solution containing at least one solvent and at least one material or its precursor, intended to cover the surface to be coated, non-volatile, film-forming, and soluble or which may be suspended or may be dispersed in the solvent;
C) generating an aerosol of the solution obtained in step B), the aerosol comprising a carrier gas phase and droplets of the solution obtained in step B);
D) generating a flow F of an aerosol from a first end of a tube to a second end of the tube with a determined section Se, provided with a projection nozzle comprising an outlet with a section S smaller than the section of the second end of the tube, so that the aerosol is accelerated between the second end of the tube and the outlet of the nozzle, and that the ratio R1=F/S is greater than 4 meters per second, preferably greater than 15 meters per second, advantageously comprised between 28 and 45 meters per second, wherein:
   F is the flow rate in cubic meters per second (m³·s⁻¹); and
   S is the outlet section of the nozzle in square meters (m²);
E) directing the outlet of the nozzle towards the surface to be coated;
F) spraying the aerosol over the surface to be coated.

According to other embodiments:
the carrier gas phase may be ambient air, preferably dried and filtered, nitrogen or argon
the carrier gas phase may be loaded with solvent vapor before step F);
the carrier gas phase may be loaded with solvent vapor during step D);
the carrier gas phase may be loaded with solvent vapor after the outlet of the nozzle;
during step B), the solvent may be an alcoholic solvent such as methanol, ethanol or isopropanol, and the soluble material may be selected from among an alcoholate of general formula M(OR)ₙ, wherein M is a metal or silicon, and R is an alkyl organic group CₙH₂ₙ₊₁, and a precursor of such an alcoholate;
during step B), the solvent may be water, and the material intended to cover the surface to be coated may be a soluble material, which may be suspended or dispersed in the water such as titanium oxide nanoparticles;
during step E), the outlet of the nozzle may be positioned at a determined distance D from the surface to be coated, so that the ratio R2=F/(S*D) is greater than 1,200 second⁻¹, preferably greater than 4,000 second⁻¹, advantageously comprised between 10,000 second⁻¹ and 45,000 second⁻¹, wherein:
   F is the flow rate in cubic meters per second (m³·s⁻¹);
   S is the outlet section of the nozzle in square meters (m²); and
   D is the distance in meters (m) between the outlet of the nozzle and the surface to be coated;
during step C), the generated flow may be such that the ratio R1=F/S is greater than 5.8*exp(160*D), preferably greater than 12.9*exp(130*D), wherein:
   F is the flow rate in cubic meters per second (m³·s⁻¹);
   S is the outlet section of the nozzle in square meters (m²); and
   exp is the exponential function;
   D is the distance in meters (m) between the outlet of the nozzle and the surface to be coated, D being comprised between 0.2 10⁻³ m and 1.5 10⁻² m, and preferably comprised between 10⁻³ m and 10⁻² m;
during step C), the generated flow may be such that the ratio R1=F/S is greater than 2.1*exp(191*D), preferably greater than 9.2*exp(112*D), wherein:
   F is the flow rate in cubic meters per second (m³·s⁻¹);
   S is the outlet section of the nozzle in square meters (m²); and
   exp is the exponential function;
   D is the distance in meters (m) between the outlet of the nozzle and the surface to be coated, D being comprised between 0.2 10⁻³ m and 2.3 10⁻² m, and preferably comprised between 10⁻³ m and 1.3 10⁻² m;
during step C), the generated flow may be such that the ratio R1=F/S is greater than 17.6*exp(114*D), preferably greater than 21.5*exp(112*D), wherein:
   F is the flow rate in cubic meters per second (m³·s⁻¹);
   S is the outlet section of the nozzle in square meters (m²); and
   exp is the exponential function;
   D is the distance in meters (m) between the outlet of the nozzle and the surface to be coated, D being comprised between 0.2 10⁻³ m and 10⁻² m, and preferably comprised between 10⁻³ m and 6.10⁻³ m; and/or
during step C), the generated flow may be such that the ratio R1=F/S is greater than 15.5*exp(100*D), preferably greater than 19*exp(96*D), wherein:
   F is the flow rate in cubic meters per second (m³·s⁻¹);
   S is the outlet section of the nozzle in square meters (m²); and
   exp is the exponential function;
   D is the distance in meters (m) between the outlet of the nozzle and the surface to be coated, D being comprised between 0.2 10⁻³ m and 1.2 10⁻² m, and preferably comprised between 10⁻³ m and 6.10⁻³ m.

The invention also relates to a device for coating a surface by spraying an aerosol over a surface, comprising:
A container of a solution containing at least one solvent and at least one material or its precursor, intended to cover the surface to be coated, non-volatile, film-forming, and soluble or which may be suspended or dispersed in the solvent
An aerosol generator able to generate an aerosol of the solution comprised in the container;
A tube connected to the container through a first end;
   the tube comprising a projection nozzle at a second end of the tube with a determined section, and in that the projection nozzle comprises an outlet with a section smaller than the section of the second end of the tube, so that during use, a flow F of aerosol is accelerated between the second end of the tube and the outlet of the nozzle.

The invention also relates to a system for coating a surface of an object by spraying an aerosol over the surface of the object, comprising:
a previous device;
a support for the object;
   the support and the outlet of the nozzle of the device being adjustable in position relatively to each other.

According to other embodiments:
the system may further comprise a means for adjusting the partial pressure in the solvent of the carrier gas phase, and/or
the system may further comprise a control unit comprising an interface, a processor, and a memory comprising a computer program for applying the previous method.

Other features of the invention will be listed in a non-limiting way in the detailed description hereafter, made with reference to the appended figures which respectively illustrate:

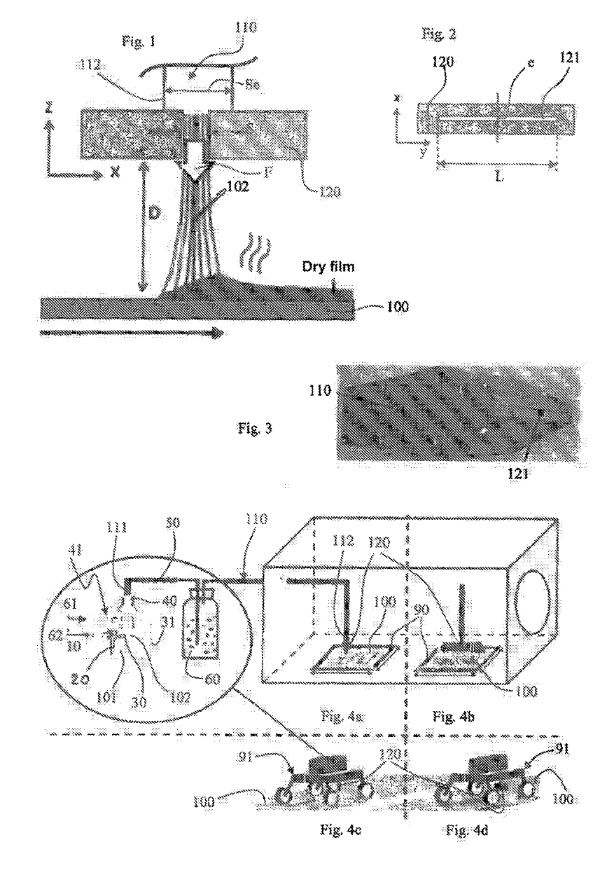

FIG. 1, a schematic sectional view of a device according to the invention;

FIG. 2, a schematic planar view of the outlet of a nozzle used in the method according to the invention;

FIG. 3, a schematic perspective view of a nozzle used in the method according to the invention;

FIGS. 4a, 4b, 4c and 4d, schematic perspective views of four embodiments of a device according to the invention;

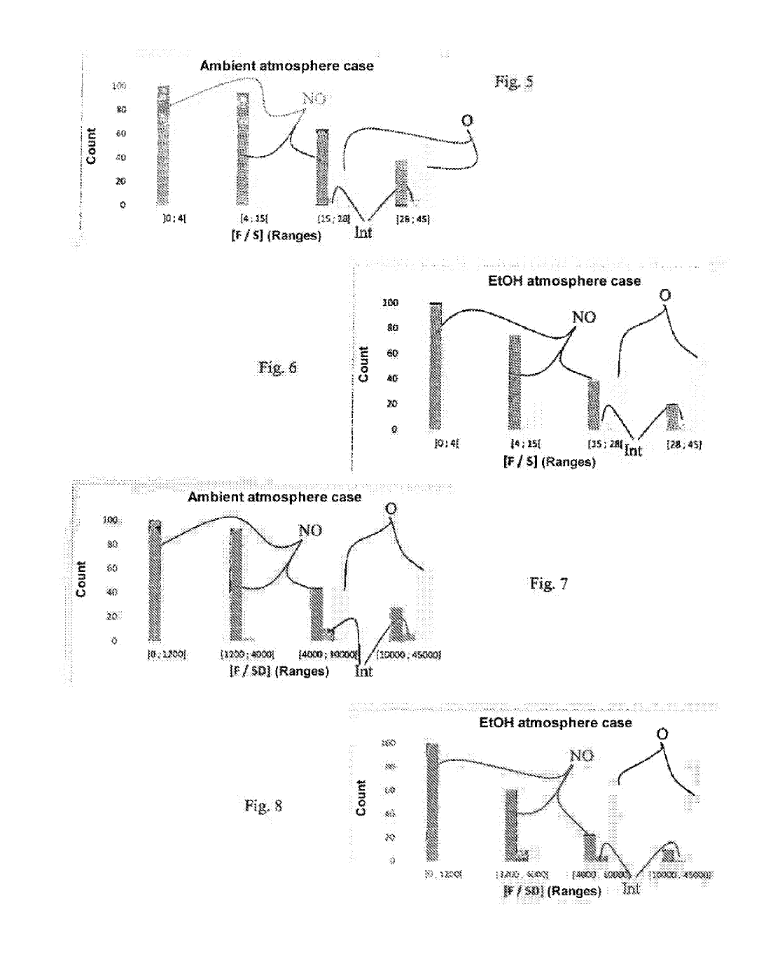

FIGS. 5 and 6, histograms illustrating the number of optical quality samples obtained versus the ratio R1=F/S with and without a controlled atmosphere;

FIGS. 7 and 8, histograms illustrating the number of optical quality samples obtained versus the ratio R1=F/SD, with and without a controlled atmosphere,

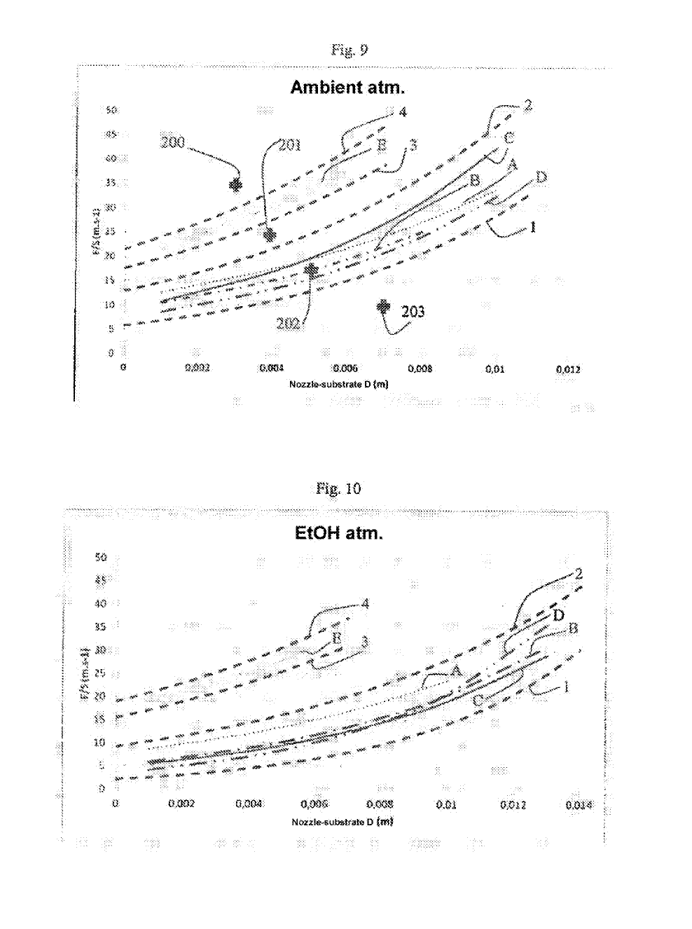

FIGS. 9 and 10, curves illustrating the minimum ratio R1=F/S to be applied according to the selected distance D, with and without a controlled atmosphere.

In the sense of the invention, an aerosol corresponds to a set of liquid particles, the composition of which corresponds to that of the initial solution, modified by the different exchange equilibria occurring with the carrier gas. The particles leaving the generator and then the nozzle have a rated size of few microns in diameter ±300% and are characterized in that they are subject to the Brownian motion which allows them to be carried away by the carrier gas without settling.

The invention proposes a coating technique by spraying an aerosol which, by its application methods, allows, unlike the known solutions of the prior art, easy deposition of optical quality layers by using a nozzle, the geometry of which depends on the geometry of the part to be coated. The nozzle generally has the role of confining the flow so that the latter arrives with an increased velocity (typically greater than 4 meters per second) on the surface to be coated.

This deposition technique is compatible with parts for which the morphology of the surface to be coated does not at least vary over the deposition distance (for example, tubes, cylinders, bars with varied section, flat or curved plates in one direction, etc).

With reference to FIGS. 1 and 4a, the invention relates to a method for coating a surface 100 by spraying a film-forming aerosol 110 on the surface, comprising the following successive steps:
A) providing the surface to be coated 100;
B) preparing a solution 101 containing at least one solvent and at least one material (organic or inorganic material) or its precursor, intended to cover the surface to be coated, non-volatile, film-forming, and soluble or which may be suspended (the particles do not settle) or which may be dispersed in the solvent (if the particles settle, they have to be maintained suspended for example by stirring);
C) generating an aerosol 102 of the solution 101 obtained in step B), the aerosol comprising a carrier gas phase and droplets of the solution obtained in step B);
D) generating a flow F of an aerosol from a first end 111 of a tube 110 towards a second end 112 of the tube with a determined section Se, provided with a projection nozzle 120 comprising an outlet 121 with a section S smaller than the section Se of the second end 112 of the tube 110, so that the aerosol is accelerated between the second end of the tube and the outlet of the nozzle, the ratio R1=F/S being greater than 4 meters per second, preferably greater than 15 meters per second, advantageously comprised between 28 and 45 meters per second, wherein:
   F is the flow rate in cubic meters per second (m³·s⁻¹); and
   S is the outlet section of the nozzle in square meters (m²);
E) directing the outlet of the nozzle towards the surface to be coated.
F) spraying the aerosol on the surface to be coated.

The aerosol is preferentially formed by a pneumatic method, from a coating liquid solution, comprising at least one non-volatile, film-forming compound and a carrier gas phase. The composition of the aerosol may be controlled at the injection or by bubbling or by enrichment after generating the aerosol.

FIG. 4a illustrates an exemplary set up for generating an aerosol.

The device comprises a pressurized air admission 10 inducing the sucking up of the liquid solution comprising the non-volatile, film-forming material in an immersed capillary 20 by the Venturi effect.

The sucked-up liquid is projected on an impactor 30 which divides it into drops falling into the tank 31 and into microdroplets making up an aerosol 102 which is directed towards the outlet 40 of the atomizer. And the aerosol is then conveyed by a pipe 50 to a washing flask filled with solvent 60 and then through a tube 110 to the substrate 100. References 61 and 62 illustrate alternative positions of the solvent flask in the set up.

The aerosol is then sprayed onto the surface 100 by means of a nozzle 120, either with a small diameter (FIG. 4a) for a selective deposit, or including a rectilinear slot (FIG. 4b) for a deposit covering a large surface.

The surface 100 may be positioned on a plate 90 with motor-driven “two-axes” translation for optional spraying round trips. In an alternative situation, the substrate is fixed while the nozzle, or even the aerosol generator, and the washing flask may be positioned on a movable apparatus 91 so as to be able to apply the deposit on already “set up” surfaces (glazings on buildings, solar panels in parks, urban furniture . . . ).

The geometry of the nozzle is such that the outlet is ideally narrow in the direction parallel to the translation and elongated in the direction perpendicular to the translation, and is adjusted to the morphology of the substrate such that the distance between the nozzle and the surface remains constant over the whole width of the deposit. The aperture of the nozzle may also have any other morphologies depending on the cases.

In the exemplary embodiment of FIGS. 2 and 3, the outlet of the nozzle is a slot with a width e and length L. The section S is therefore equal to L*e. The length of the nozzle and therefore of the slot is 5 cm.

Advantageously, according to the invention, the ejection of the aerosol towards the surface 100 is ensured by means of a nozzle 120, the outlet 121 of which is positioned at a determined distance D, in meter (m), from the surface to be coated, so that the ratio R2=F/(S*D) is greater than 1,200 second⁻¹, preferably greater than 4,000 second⁻¹, advantageously comprised between 10,000 second⁻¹ and 45,000 second⁻¹.

The inventors realize that by positioning the outlet of the nozzle at a distance D determined craftily, it is possible to obtain quasi-systematically coatings of optical quality with strong aerosol velocity values, thereby accelerating the method.

The relationship between the velocity of the aerosol and the distance D is of the type V=α*exp(β*D), wherein α and β are numerical coefficients, and exp is the exponential function.

The numerical coefficients α and β depend on the type of solution used (alcoholic solution or aqueous solution) and on the presence or on the absence of a controlled atmosphere.

In a first case, the composition of the carrier gas phase is that of ambient air, and the solution used is an alcoholic solution: the solvent is an alcohol such as ethanol EtOH and the soluble material is selected from an alcoholate of general formula M(OR)ₙ, wherein M is a metal or silicon, and R is an alkyl organic group CₙH₂ₙ₊₁, and a precursor of such an alcoholate.

In this case, during step C), the generated flow F is such that the ratio R1=F/S is greater than 5.8*exp(160*D), preferably greater than 12.9*exp(130*D), wherein:
F is the flow rate in cubic meters per second (m³·s⁻¹);
S is the outlet section of the nozzle in square meters (m²);
exp is the exponential function;
D is the distance in meters (m) between the outlet of the nozzle and the surface to be coated, D being comprised between 0.2 10⁻³ m and 1.5 10⁻² m, and preferably comprised between 10⁻³ m and 10⁻² m.

In a second case, the composition of the carrier gas phase is ambient air which was modified in that the air flow is loaded with solvent vapor before step F) (during step D) or after leaving the nozzle, for example by means of a chamber with a controlled atmosphere), and the solution used is an alcoholic solution.

In this case, during step C), the generated flow is such that the ratio R1=F/S is greater than 2.1*exp(191*D), preferably greater than 9.2*exp(112*D), wherein:
F is the flow rate in cubic meters per second (m³·s⁻¹);
S is the outlet section of the nozzle in square meters (m²); and
exp is the exponential function;
D is the distance in meters (m) between the outlet of the nozzle and the surface to be coated, D being comprised between 0.2 10⁻³ m and 2.3 10⁻² m, and preferably comprised between 10⁻³ m and 1.3 10² m;

In a third case, the composition of the carrier gas phase is ambient air, and the solution used is an aqueous solution: the solvent is water, and the material intended to cover the surface to be coated is a soluble material, which may be suspended or may be dispersed in water such as titanium oxide nanoparticles.

In this case, wherein during step C), the generated flow is such that the ratio R1=F/S is greater than 17.6*exp(114*D), preferably greater than 21.5*exp(112*D), wherein:
F is the flow rate in cubic meters per second (m³·s⁻¹);
S is the outlet section of the nozzle in square meters (m²); and
exp is the exponential function;
D is the distance in meters (m) between the outlet of the nozzle and the surface to be coated, D being comprised between 0.2 10⁻³ m and 10⁻² m, and preferably comprised between 10⁻³ m and 6.10⁻³ m.

In a fourth place, the composition of the carrier gas phase is ambient air which was modified in that the air flow is loaded with solvent vapor before being sprayed, and the solution used is an aqueous solution.

In this case, during step C), the generated flow is such that the ratio R1=F/S is greater than 15.5*exp(100*D), preferably greater than 19*exp(96*D), wherein:
F is the flow rate in cubic meters per second (m³·s⁻¹);
S is the outlet section of the nozzle in square meters (m²); and
exp is the exponential function;
D is the distance in meters (m) between the outlet of the nozzle and the surface to be coated, D being comprised between 0.2 10⁻³ m and 1.2 10⁻² m, and preferably comprised between 10⁻³ m and 6.10⁻³ m.

The use of a nozzle gives the possibility of:
(i) preventing evaporation of the droplets which may be rapid;
(ii) increasing the velocity of the microdroplets of the aerosol in order to promote their spreading upon their impact on the surface;
(iii) maintaining this flow constant on a section of the surface 100 to be coated, in order to prevent any modifications of the characteristics which may locally modify the optical properties of the layer; and
(iv) maintaining as long as possible the composition of the atmosphere, around the coated areas, close to the composition of the carrier gas at the outlet of the nozzle.

The homogeneity of the deposit, in terms of thickness and structure, depends on the rheology of the initial solution (viscosity, surface tension, volatility, etc.), on the conditions for generating the aerosol (pressure, flow, composition of the carrier gas), on the type of aerosol generator used, but mainly here by the distance between the surface and the nozzle.

The thickness of the deposit is directly proportional to the deposited amount per unit surface.

In order to give optical quality to the elaborated films, the microdroplets should arrive provided with a solvent on the surface in order to wet the surface and to coalesce together in order to form a thin liquid layer. In other words, the evaporation of the solvent leading to the condensation of the precursors and to the formation of the gel and then of the solid film should only occur after the deposition phase.

An atmosphere enriched with solvent (0<relative vapor pressure P_{R}(solvent)<100%) during this phase may prove to be necessary in order to slow down the natural evaporation of the solvent of the droplets of the aerosol. For this, the gas carrier flow transporting the droplets is passed into a bubbler 60 filled with a solvent, for example ethanol, in order to be also loaded with vapor of this solvent before being sprayed onto the substrate. The solvent level should be controlled so as to remain equal during the deposition. With this particularity, the control of the atmosphere during the deposition is thus managed upstream and therefore does not require necessarily a closed chamber around the outlet.

In order to control the application of the droplets onto the substrate in a very thin way and thus control the properties of the deposit, in particular its homogeneity, a nozzle is applied at the end of the transport. It gives the possibility of channeling the flow of particles before their arrival on the substrate. The applied nozzle may have shapes adapted to the desired deposition depending a thin localized covering or on the covering of a large surface area.

As illustrated in FIGS. 4a and 4b, the aerosol may be applied via the nozzle, perpendicularly to a substrate resting in a horizontal position on a motor-driven support allowing its translation along two directions.

Alternatively, as illustrated in FIGS. 4c and 4d, the nozzle may be placed on a motor-driven device allowing it to have any type of movement (translation, rotation, tilt) with respect to the substrate.

Both alternatives may be combined for more flexibility.

The main difference relatively to the state of the art relates to the velocity of the aerosol flow arriving on the surface. In the present invention, everything is applied for accelerating the aerosol (droplets+carrier gas) to above four meters per second. On the other hand, in the devices of the state of the art, everything is applied for maintaining the flow as slow as possible as explained in the introduction.

The film-forming initial solution may be of any kinds, but those which apply in priority to this invention are sol-gel solutions (either organic or inorganic or mixed). According to a particular embodiment of the solution, the film precursor corresponds to a mixture of several non-volatile compounds, and the solvent is typically selected so that it is capable of producing a homogeneous dispersion, or total solubilization of the precursor species) and that it may evaporate under the deposition conditions. These are typically alcoholic or hydro-alcoholic solutions.

The carrier gas is selected from gases or mixtures of gases capable of remaining in the gaseous state during the whole of the steps of the method. It is generally not very, and preferably not at all reactive with the coating solution, i.e. it will not substantially modify the chemical properties unless if this is desired. The carrier gas is generally introduced into the system as a continuous or discontinuous flow and able to participate into the formation of the aerosol. This will be in the majority of the cases, pressurized air of industrial quality, but any other compositions may be contemplated, notably a neutral gas such as nitrogen or argon.

The aerosol may be formed with the different techniques known to one skilled in the art. Mention may notably be made of atomization, which corresponds to the subdivision of a liquid into liquid particles of small size, by means of a pneumatic atomizer, notably with impact, either ultrasonic or electrostatic. In the three cases, the solution is transformed into droplets, respectively by the pressure forces, the vibration/cavitation forces, and the electrostatic repulsion/attraction forces which overcome the surface tension and viscosity forces governing the initial state of the solution.

Pneumatic atomization is generally designated by the name of “two-fluid atomization” since it implies the crossing of the liquid solution with a pressurized gas, generally air. Different mechanisms may be encountered such as simple pressurized atomization, atomization by centrifugation, assisted atomization with air, assisted atomization with an air jet, atomization with effervescence or further impact atomization (and a Venturi or collision effect).

Ultrasonic atomization implies the contact between the liquid solution and a surface excited by ultrasonic waves. Both routes are mainly used in order to allow this contact: either the liquid crosses a vibrating nozzle excited by ultrasonic waves, or the liquid is poured into a glass container equipped with a piezoelectric ceramic transducer.

Electrostatic atomization implies a conductive substrate and a very high voltage (between 3 and 15 kV) issued between the latter and a metal capillary wire through which passes the solution. The droplets generated at the outlet of the capillary, by repulsion between similar charges in the ionized liquid, are directly directed in a direction as a response to the imposed electric field.

The pneumatic atomization method of the solution into droplets is preferred. It is generally carried out by means of a pneumatic atomizer by impact, also called atomizer by the Venturi or collision effect. The principle is based on an admission of pressurized air into the atomizer inducing suction by the Venturi effect of the liquid coating solution, contained in a tank, in an immersed capillary. At the non-immersed end of the capillary, there is projection of the liquid sucked up on an impactor, such as a small sphere which divides it into microdroplets. The larger droplets fall into the tank while the smaller ones form an aerosol automatically directed towards the outlet of the atomizer.

The use of linear nozzles (for which the length may be less than or equal to the width of the surface to be treated) gives the possibility of producing deposits in only one pass without having to adjust the sweeping deviations which may generate covering defects. The latter may be a succession of base units which are attached together. The number of base units will define the pass width. Each unit will be equipped with one or several aerosol emissions depending on their length. The flow may be optimized by adding an internal part used for breaking the direction of the flow.

By its flexibility, the invention further gives the possibility of producing deposits from coating solutions of different natures and notably from solutions initially non-miscible with each other.

The invention may be applied by means of several aerosols. It is thus possible in step (c) to prepare several aerosols of different nature, and notably comprising different film precursors. These aerosols may be joined up beforehand with the vapor enrichment or before the injection. Thus, the invention also relates to a method for coating a surface with a mixture of aerosols comprising the successive steps of generation, enrichment, mixing, ejection.

The methods described above may be applied in several times on a same surface, it is thus possible to obtain a superposition of films, which for example may be of different natures.

By varying the proportion of the aerosols mixed before ejection, it is also possible to obtain a composite gradient of the deposited films.

The invention also relates to a device and to a system for applying the method described above.

The device comprises:
A container 41 of a solution containing at least one solvent and at least one material, or its precursor, intended to cover the surface to be coated, non-volatile, film-forming and soluble or which may be suspended or may be dispersed in the solvent;
An aerosol generator 30 able to generate an aerosol of the solution comprised in the container;
A tube 50-110 connected to the container 41 through a first end 111;
Optionally a flow generator in order to accelerate the aerosol in the tube.

The tube 50-110 comprises a projection nozzle 120 at a second end 112. The projection nozzle comprises an outlet with a section S smaller than the section of the inlet, so that during use, a flow F of aerosol is accelerated between the inlet and the outlet of the nozzle.

The invention also relates to a complete system for coating a surface of an object, the system comprising the preceding device as well as a support for the object, the support and the outlet of the nozzle of the device being adjustable in position relatively to each other.

Advantageously, the system according to the invention is controlled by a computer. For this purpose, it comprises a control unit provided with an interface, a processor and a memory comprising a computer program for applying the method according to the invention.

Typically, the user may enter, depending on the surface to be coated and on the aerosol solution used, the flow velocity which is the best adapted to its device, and the processor will automatically command a movement between the outlet of the nozzle and the surface to be coated for laying them out at the distance D required by the method according to the invention, either with the ratio R2, or with the relationship of the type a*exp(VD) between the ratio R1 and distance D.

The system is preferably equipped with means, preferably automated means, allowing its displacement relatively to the surface, in particular when it is supported on the latter, as well as means allowing specific displacement of the coating device.

The system also advantageously comprises a means for adjusting the partial pressure of the solvent of the carrier gas phase such as for example, a bubbler.

The invention is a comprehensive invention since it may be used for different types of deposits, coating or film, like the localized thin deposit (network) or the total deposit covering large surfaces, notably by means of the possible use of nozzles with different sizes and shapes.

The use of a mask, of variable patterns, is also possible within the scope of the invention. The surface may thus be partly protected from the coating. The coating and the selection of a suitable mask is within the reach of one skilled in the art.

### Exemplary Embodiments

Several solutions were tested for applying the method according to the invention. The compositions, in grams, of these solutions are copied into the following table:

| | | | | | TiO₂ (np. | | | | | |
|---|---|---|---|---|---|---|---|---|---|---|
| | | | | | 15-30 | | | | | |
| | | | | | nm 10% | | HCl | HCl | | |
| Solution | Name | TEOS | MTEOS | TiCl₄ | in H₂O) | F127 | 12M | 0.1M | H₂O | EtOH |
| Mesoporous | A | 5 | 5 | | | 2.27 | | 4.5 | | 80 |
| SiO₂ | | | | | | | | | | |
| Dense SiO₂ | B | 12 | | | | | 0.6 | | 3.5 | 80 |
| SiO₂-TiO₂ | C | 5 | | 4.6 | | | | | 3 | 80 |
| 50-50 dense | | | | | | | | | | |
| TiO₂ dense | D | | | 8.5 | | | | | 2.5 | 80 |
| TiO₂ | E | | | | 22 | | | | 50 | |
| nanoparticles | | | | | | | | | | |
| in H₂O | | | | | | | | | | |

The atomizer used is TOPAS ATM210-H (pneumatic atomizer by impact). According to the data of the manufacturer, the average diameter of droplets generated from water alone is between 0.5 μm and 1 μm.

It has been shown that for similar atomizers, the polydispersed particles generated from a solution based on the methanol solvent include a diameter comprised between 0.0035 μm and 35.00 μm.

The flow values, measured by means of a flowmeter, at the outlet of the aerosol generator and at the outlet of the nozzle depend on the pressure and the correspondence table is given below.

| | Pressure (bars) | | | |
|---|---|---|---|---|
| | 1 | 2 | 3 | 4 |
| Flow at the outlet of the generator | 19.5 | 29.5 | 38.4 | 48.2 |
| (L/min) | | | | |
| Velocity at the outlet of the nozzle | 5.9 | 8.9 | 11.6 | 14.6 |
| e = 1 mm (m/s) | | | | |
| Velocity at the outlet of the nozzle | 16.3 | 24.5 | 32.0 | 40.1 |
| e = 0.3 mm (m/s) | | | | |

The deposition conditions are 25° C./atmospheric pressure. The carrier gas is in every case compressed, filtered and dried air. The same results were obtained with compressed nitrogen with a purity >99.99%.

The depositions were carried out without (ambient atmosphere), or with (EtOH atmosphere) enrichment of the carrier gas with ethanol vapor by means of a mixture, before the nozzle, with air having passed into an ethanol bubbler (V=150 mL/T=40-45° C./output flow rate≈5 to 6 l/min). The deposits were carried out with nozzles with a slot width e comprised between 0.4 mm and 1.4 mm and at the distances between the nozzle and the substrate D varying from 1 to 13 mm.

The nozzle used for the tests comprises an outlet having a rectangular slot. The section S of the outlet is therefore equal to the length L multiplied by the width e of the slot.

The substrates are pieces of silicon 100 cleaned beforehand with acetone and then with ethanol.

The translation velocity relatively to the nozzle and to the surface to be coated was set to 7 mm·s⁻¹ in the direction of the x axis with reference to FIG. 1, so as to deposit a sufficient amount of solution per unit surface for allowing the formation, of a layer in the thickness range for which the iridescences related to optical interferences, indicators of optical quality, are visible. This velocity further gives the possibility of adjusting the thickness of the layer. Of course, the invention is not limited by this deposition velocity.

During the translation, the velocity of the flow is varied by incrementing the pressure of the gas injected into the aerosol generator by 0.5 bars every 20 mm between 0.5 bars and 4.5 bars, so as to compare the effect of the velocity of the aerosol flow on a same sample.

The graphs of FIGS. 5 to 8 summarise the obtained results, all solutions A, B, C, D and E included.

On these histograms, the samples are grouped under three categories: the bars NO represent the surface samples having poor optical quality, the bars O represent the surface samples having good optical quality, and the bars Int represent the surface samples having an intermediate optical quality.

The histograms of FIGS. 5 and 6 illustrate the number of samples in each category for different ratio R1 intervals (flow velocity F).

In the velocity range F/S ranging from 0 to 4 metres per second exclusively, no sample has good optical quality or even an intermediate optical quality, and this regardless of the solution A, B, C, D or E used.

It is only from 4 metres per second, when one begins to obtain samples having good optical quality (about 3.2%).

In detail, in the range ranging from 4 to 15 metres per second, only the alcoholic solutions A, B, C and D give the possibility of obtaining samples with good optical quality: solution A gives the possibility of obtaining a few samples having a good optical quality (2 out of 156, i.e. about 1.5%), solutions B and C give the possibility of obtaining a little more of them (5 out of 156, i.e. about 3.2%), and solution D gives the possibility of obtaining even more (13 out of 156, i.e. about 8.3%).

The aqueous solution E only gives the possibility of obtaining samples of good optical quality from 15 metres per second.

The upper ranges of the ratio R1 show that the higher the velocity, the more the number of samples of good optical quality increases.

This goes against all the biases of the state of the art.

This result is true, whether the composition of the carrier gas phase is controlled or not. Of course, between FIGS. 5 and 6, it is noticed that the presence of a controlled atmosphere facilitates the obtaining of samples of good optical quality, since at an equivalent velocity, the obtained proportion of samples of good optical quality is greater: all solutions included, for the intervals 4-15, 15-28 and 28-45, one obtains respectively 3.2%, 28.9% and 53.9% of samples having good optical quality without any controlled atmosphere, and 19.5%, 52.6% and 73.3% of samples of good optical quality under a controlled ethanol EtOH atmosphere.

However, in order to ensure that the aerosol arrives with sufficient velocity on the surface, the nozzle should not be too far from the surface to be coated. This is illustrated by the histograms of FIGS. 7 and 8 illustrating the number of samples in each category, for different ratio R2 intervals (flow F velocity divided by the distance D between the outlet of the nozzle and the surface to be coated).

These histograms show that the ratio R2 should at least be 1,200 seconds⁻¹, in order to obtain samples of good optical quality.

Like for the histograms of FIGS. 5 and 6, the more R2 increases, the more increases the proportion of samples of good optical quality. Also, the presence of an ethanol atmosphere further increases the obtained proportions.

The inventors noticed that there exists a relationship between the distance D and the ejection velocity giving the possibility of quasi-systematically obtaining coatings with optical qualities.

The relationship between the velocity of the aerosol and the distance D is of the type V=α*exp(β*D), wherein α and β are numerical coefficients, and exp is the exponential function.

The results of the experiments are illustrated by the curves of FIGS. 9 and 10.

Generally, these curves provide three teachings:

The first is the relationship F/S=α*exp(β*D): for a given solution, any pair (F/S; D) located above the curve F/S=αₛₒₗ*exp(βₛₒₗ*D) gives the possibility of quasi-systemically obtaining samples of good optical quality. Thus:
The pair 200 (25 m·s⁻¹; 0.003 m) is located above all the curves of the tested solutions, and will give the possibility of quasi-systematically obtaining samples of good optical quality;
   The pair 201 (25 m·s⁻¹; 0.004 m) is located above all the curves of the alcoholic solutions, and will give the possibility of quasi-systematically obtaining samples of good optical quality with these solutions, but very little with an aqueous solution E;
   The pair 202 (17 m·s⁻¹; 0.005 m) is located above the curve of the solution D and on the curve of solution B. It will give the possibility of quasi-systematically obtaining samples of good optical quality with these two solutions, but much less with the solutions A and C, and even less with the aqueous solution E;
   The pair 203 (10 m·s⁻¹; 0.007 m) is located below all the curves of the tested solutions and will only give the possibility of obtaining very few samples of good optical quality.
The second is that at equal distances, alcoholic solutions give the possibility of obtaining samples of good optical quality at lower velocities than the aqueous solutions; as a corollary, at equal velocities, the alcoholic solutions give the possibility of obtaining samples with good optical quality at larger distances D.
The third is that the presence of an ethanol EtOH atmosphere decreases the coefficients α and β, which means that the method is more flexible since the velocities to be applied are lower and that the distance D may be larger.

Curves 1 and 2 in dashed lines illustrate empirically, an “application corridor”, acceptable for the alcoholic solutions A, B, C and D. Also the curves 3 and 4 empirically illustrate an “application corridor” acceptable for the aqueous solutions E.

The method according to the invention therefore gives the possibility of obtaining surfaces with optical quality more rapidly than with the known methods, since the projection velocity is increased. For 2 different F/S ratios, it is possible to obtain identical optical qualities by acting on the translation velocity parameter.

Further, it is possible to combine the velocity of the flow and the distance of the nozzle from the surface in order to dimension an economical device.

Sol-gel formulations with precursors of the TiCl₄ type (for TiO₂ films) or TEOS (for SiO₂ films) were tested with as a majority solvent methanol or isopropanol.

The compositions, in grams, of these solutions are given in the following table:

| | | | | HCl | | | |
|---|---|---|---|---|---|---|---|
| Solution | Name | TEOS | TiCl₄ | 12M | H₂O | Methanol | Isopropanol |
| Dense SiO₂-methanol | F | 12 | | 0.6 | 3.5 | 80 | — |
| Dense SiO₂-isopropanol | G | 12 | | 0.6 | 3.5 | — | 80 |
| Dense TiO₂-methanol | I | | 8.5 | | 2.5 | 80 | |
| Dense TiO₂-isopropanol | J | | 8.5 | | 2.5 | | 80 |

The more the alcoholic solvent is volatile, the more the risk is incurred that the solution evaporates rapidly and that the deposit is “dry” and therefore of a non-optimum optical quality. With a not very volatile alcoholic solvent, the deposit is on the other hand “too liquid” and the homogeneity of the film becomes difficult to control during the deposition.

For solutions based on methanol, more volatile than ethanol, an optical quality deposit was obtained by using a nozzle including a slot with a width e of less than 0.6 mm and with a distance between the nozzle and the substrate of less than 7 mm (without applying the additional solvent bubbler). Good results were obtained with an injected gas pressure in the aerosol generator from 3 to 4 bars.

For the solutions based on isopropanol, a little less volatile than ethanol, the behaviour of the layers is similar to those obtained with the ethanol solvent and the parameters to be adjusted for good optical quality and good homogeneity are almost the same.

Deposition tests were carried out with a nozzle with a length L equal to 16 cm instead of 5 cm, the width of the outlet slot being 0.4 mm. It is observed that the covering of the substrate is actually present over 16 cm of width, i.e. the effective length of the outlet slot of the nozzle. Of course, the invention is not limited by the length of the slot.

The deposition tests already carried out gave the possibility of obtaining homogeneous coatings in thickness and with optical quality with a thickness comprising between 5 nm and 1,000 nm. Tests carried out with an industrial formulation (of an unspecified composition) led to homogeneous coatings and with optical quality, with a thickness of 4,400 nm. Depending on the chemical solution to be deposited, it may therefore be considered that the conceivable thickness range with the method according to the invention, while retaining a homogeneous deposit and with optical quality, is not restricted to the range 5 nm-1,000 nm but in the range from 5 nm to several microns. The thicker the film, the higher is the risk of inhomogeneity in thickness. The inhomogeneity is determined in the following way:
The thickness of the layer is measured by ellipsometry or in electron microscopy in different points of the layer (for example 10 points),
The measured thickness values are averaged,
The largest deviation relatively to the average is indicated as a percent of this average value and represents the inhomogeneity.

It may be estimated that within the scope of the invention, it is located between 6% (for the less thick coatings) and 14% (for the thickest coatings).

1. A method for coating a surface by spraying an aerosol over a surface, comprising the steps of:
A) providing a surface to be coated;
B) preparing a solution containing at least one solvent and at least one material or its precursor, intended to cover the surface to be coated, non-volatile, film-forming, and soluble or which may be suspended or dispersed in the solvent;
C) generating an aerosol of the solution obtained in step B), the aerosol comprising a carrier gas phase and droplets of the solution obtained in step B);
D) generating a flow rate (F) of aerosol from a first end of a tube towards a second end of the tube, with a determined section (Se), provided with a projection nozzle comprising an outlet with a section (S) less than the section of the second end of the tube, so that the aerosol is accelerated between the second end of the tube and the outlet of the nozzle, and that the ratio R1=F/S is greater than 4 metres per second, preferably greater than 15 metres per second, advantageously comprised between 28 and 45 metres per second, wherein F is the flow rate in cubic metres per second (m³·s¹); and S is the output section of the nozzle in square metres (m²);
E) directing the output of the nozzle towards the surface to be coated; and
F) spraying the aerosol on the surface to be coated.

2. The method according to claim 1, wherein the carrier gas phase is ambient air, or a neutral gas such as nitrogen or argon.

3. The method according to one of claim 1, wherein the carrier gas phase is loaded with solvent vapour before step F).

4. The method according to one of claim 1, wherein the carrier gas phase is loaded with solvent vapour during step D).

5. The method according to claim 4, wherein the carrier gas phase is loaded with solvent vapour after exiting the nozzle.

6. The method according to claim 1, wherein, during step B), the solvent is an alcoholic solvent such as methanol, ethanol or isopropanol, and the soluble material is selected from among an alcoholate of general formula M(OR)ₙ, wherein M is a metal or silicon, and R is an alkyl organic group CₙH₂ₙ₊₁, and a precursor of such an alcoholate.

7. The method according to claim 1, wherein, during step B), the solvent is water, and the material intended to cover the surface to be coated is a soluble material, which may be suspended or may be dispersed in the water such as titanium oxide nanoparticles.

8. The method according to claim 1, wherein, during step E), the outlet of the nozzle is positioned at a determined distance D from the surface to be coated, so that the ratio R2=F/(S*D) is greater than 1,200 second⁻¹, preferably greater than 4,000 second⁻¹, advantageously comprised between 10,000 second⁻¹ and 45,000 second⁻¹, wherein:
F is the flow rate in cubic metres per second (m³·s¹);
S is the outlet section of the nozzle in square metres (m²); and
D is the distance in metres (m) between the outlet of the nozzle and the surface to be coated.

9. The method according to claim 1, wherein, during step C), the generated flow is such that the ratio R1=F/S is greater than 5.8*exp(160*D), preferably greater than 12.9*exp(130*D), wherein:
F is the flow rate in cubic metres per second (m³·s⁻¹);
S is the outlet section of the nozzle in square metres (m²);
exp is the exponential function; and
D is the distance in metres (m) between the outlet of the nozzle and the surface to be coated, D being comprised between 0.2 10⁻³ m and 1.5 10⁻² m, and preferably comprised between 10⁻³ m and 10⁻² m.

10. The method according to claim 1, wherein, during step C), the generated flow is such that the ratio R1=F/S is greater than 2.1*exp(191*D), preferably greater than 9.2*exp(112*D), wherein:
F is the flow rate in cubic metres per second (m³·s⁻¹);
S is the outlet section of the nozzle in square metres (m²);
exp is the exponential function; and
D is the distance in metres (m) between the outlet of the nozzle and the surface to be coated, D being comprised between 0.2 10⁻³ m and 2.3 10⁻² m, and preferably comprised between 10⁻³ m and 1.3 10⁻² m.

11. The method according to claim 1, wherein, during step C), the generated flow is such that the ratio R1=F/S is greater than 17.6*exp(114*D), preferably greater than 21.5*exp(112*D), wherein:
F is the flow rate in cubic metres per second (m³·s⁻¹);
S is the outlet section of the nozzle in square metres (m²);
exp is the exponential function; and
D is the distance in metres (m) between the outlet of the nozzle and the surface to be coated, D being comprised between 0.2 10⁻³ m and 10⁻² m, and preferably comprised between 10⁻³ m and 6.10⁻³ m.

12. The method according to claim 1, wherein, during step C), the generated flow is such that the ratio R1=F/S is greater than 15.5*exp(100*D), preferably greater than 19*exp(96*D), wherein:
F is the flow rate in cubic metres per second (m³·s¹);
S is the outlet section of the nozzle in square metres (m²);
exp is the exponential function; and
D is the distance in metres (m) between the outlet of the nozzle and the surface to be coated, D being comprised between 0.2 10⁻³ m and 1.2 10⁻² m, and preferably comprised between 10⁻³ m and 6.10⁻³ m.

13. A device for coating a surface by spraying an aerosol on a surface, comprising:
A container of a solution containing at least one solvent and at least one material or its precursor, intended to cover the surface to be coated, non-volatile, film-forming and soluble or which may be suspended or may be dispersed in the solvent,
An aerosol generator able to generate an aerosol of the solution comprised in the container; and
A tube connected to the container through a first end;
wherein the tube comprises a projection nozzle at a second end of the tube with a determined section (Se), and in that the projection nozzle comprises an outlet with a section (S) of less than the section (Se) of the second end of the tube, so that upon use, an aerosol flow F is accelerated between the second end of the tube and the outlet of the nozzle.

14. A system for coating a surface of an object by spraying an aerosol on the surface of the object, comprising:
a device according to claim 13;
a support for the object;
the support and the outlet of the nozzle of the device being adjustable in position relatively to each other.

15. The system according to claim 14, further comprising a means for adjusting the partial pressure of the solvent of the carrier gas phase.

16. A system for coating a surface of an object by spraying an aerosol on the surface of the object, comprising:
a device comprising:
a container of a solution containing at least one solvent and at least one material or its precursor, intended to cover the surface to be coated, non-volatile, film-forming and soluble or which may be suspended or may be dispersed in the solvent,
an aerosol generator able to generate an aerosol of the solution comprised in the container; and
a tube connected to the container through a first end, wherein the tube comprises a projection nozzle at a second end of the tube with a determined section (Se), and the projection nozzle comprises an outlet with a section (S) of less than the section (Se) of the second end of the tube, so that upon use, an aerosol flow F is accelerated between the second end of the tube and the outlet of the nozzle;
a support for the object, the support and the outlet of the nozzle of the device being adjustable in position relatively to each other; and
a control unit comprising an interface, a processor, and a memory comprising a computer programme for applying the method according to claim 1.
